(19) United States
(12) Patent Application Publication
(10) Pub. No.: US 2021/0037783 A1
(43) Pub. Date: Feb. 11, 2021

(54) PET FEEDER

(71) Applicant: Leanna Shuttleworth, Brooklyn, NY (US)

(72) Inventor: Leanna Shuttleworth, Brooklyn, NY (US)

(21) Appl. No.: 16/988,433

(22) Filed: Aug. 7, 2020

Related U.S. Application Data
(60) Provisional application No. 62/884,260, filed on Aug. 8, 2019.

(51) Int. Cl. A01K 5/01; A01K 5/02

(52) U.S. Cl. CPC A01K 5/0114; A01K 5/0291; A01K 5/0275

(57) ABSTRACT

A pet feeder that includes an automatic and programmable pet food dispenser and a puzzle tray having a pet food reception area for receiving the pet food from the automatic pet food dispenser, the puzzle tray permitting the pet to interact with the puzzle and access the food in the food reception area from at least one side, or from opposite sides to allow more than one pet to interact with the puzzle and access the food in the food reception area.

### CROSS-REFERENCE TO RELATED APPLICATION

This application claims priority to U.S. Provisional Application No. 62/884,260 filed on Aug. 8, 2019, the entire disclosure of which is incorporated by reference.

### FIELD OF THE INVENTION

The present invention relates to an automatic pet feeding system, specifically to an automated puzzle feeder for cats.

### BACKGROUND

Puzzle feeders (food bowls that include a puzzle, maze or other interactive method for the pet to solve to be able to access the food) are highly recommended by veterinarians as the main method of feeding for all cats to promote wellbeing. The mental and physical stimulation provided by puzzle feeders reduces stress; combats medical conditions such as feline idiopathic cystitis, overgrooming, inappropriate urination, obesity and aggression; slows down eating; and provides entertainment. Automatic feeders provide convenience and ease and allow for leaving cats unattended for short periods of time. In addition, cats are known for demanding food at inconvenient hours and automatic feeders are generally recognized as the most effective solution for this.

### SUMMARY OF THE INVENTION

It is an object of the present invention to provide a pet feeder.

A feeder according to the present invention would be used for feeding cats and providing environmental enrichment.

A feeder according to the present invention offers a new opportunity to combine two types of feeders for convenience and ease while also providing the gold standard method of feeding for the health and wellbeing of cats.

A feeder according to the present invention is a combination of an automatic feeder and a puzzle feeder designed for cats. The feeder will automatically dispense food into a puzzle at pre-set times and in pre-set quantities. The times, quantity and frequency of food being dispensed will be inputed by the user via an interface directly on the automatic dispenser or via Bluetooth/Wi-Fi connection to a mobile smartphone application. The puzzle will be located in an interchangeable tray located at the base of the automatic dispenser. The interchangeable puzzle tray may consist of a plastic divider tray of approximately 12″ width×14″ length×2″ height for the cat to pull or paw the food out to eat, and could include some moveable options such as spinning pieces to enhance entertainment, or a plastic maze that the cat has to manipulate the food through. The puzzle tray may be rectangular in shape and made of FDA-approved and food grade/safe hard plastic that is dishwasher safe; it could also have the option of a stainless-steel version for cats with feline acne issues.

The automatic component to the feeder preferably has an exterior cabinet of approximately 14″ height×12″ width×6″ depth, a base supporting the exterior cabinet and an open cavity 3″ high located at the bottom on the exterior cabinet for placement of the puzzle tray. The cavity could be approximately 1″ taller than the puzzle tray to allow the cat to visualize the food when dispensed. The exterior cabinet will include a gated hatch located on the top of the unit for depositing the food, an internal section of approximately 5.5 liters for storing the food, an internal section to house necessary electronic and mechanical components, and a gated hatch located in the center on the bottom of the unit for the food to be dispensed into the puzzle tray. The system can run on standard 110-volt electricity and will be designed and engineered with Bluetooth/Wi-Fi capabilities. An LCD display and interface panel can be located on the front of the automatic dispenser for optional programming of feeding times, quantity and frequency directly on the feeder. Alternatively, this could be done via smartphone app.

Two versions will be available: 1) A centrally located automatic dispenser, so that the food falls into the center of the puzzle and is accessible from both sides, 2) A single direction dispenser, where the food will fall into the first ⅓ of the puzzle tray and will only be accessible from one side. The centrally located dispenser provides a unique way of more evenly dispensing food into the puzzle and combatting competitive eating behaviors between multiple cats within a household by allowing two approaches to the food.

Specific measurements and details are illustrative embodiments of this invention.

Variations may include an internal camera to permit viewing the cat as it figures out the puzzle, and variations of color, size and styles.

Other features and advantages of the present invention will become apparent from the following description of the invention which refers to the accompanying drawings.

### BRIEF DESCRIPTION OF THE DRAWING(S)

FIG. 1 shows the automatic feeder component, with: 1) Exterior cabinet, 2) Removable hatch, 3) Open cavity for puzzle tray, 4) LCD display and interface panel, 5) Hooks to hold puzzle tray in place, 6) Gated hatch for food dispensing.

FIG. 2 shows the automatic feeder with centrally located dispenser with: 10) Exterior cabinet, 11) Puzzle tray, 12) Access to food, 13) Alternative access to food, 14) Gated hatch for food dispensing.

FIG. 3 shows the automatic feeder with a single direction dispenser having: 20) Puzzle tray, 21) Access to food, 22) Gated hatch for food dispensing.

FIGS. 4A and 4B show a puzzle tray example for a single direction dispenser with: 30) Exterior of puzzle tray, 31) Curved wall plastic dividers, 32) Vertical cone plastic dividers, 33) Area in which food is dispensed into, 34) Access to food.

FIG. 5 shows an aerial view of a puzzle tray example for a centrally located dispense with: 40) Area in which food is dispensed into through centrally located automatic feeders of FIG. 2, 41) Exterior of puzzle tray, 42) Curved wall plastic dividers, 43) Vertical cone plastic dividers, 44) Access to food, 45) Alternative access to food.

### DETAILED DESCRIPTION OF EMBODIMENTS OF THE INVENTION

While the above identifies the figures and the various parts, a brief narrative is provided below for further understanding.

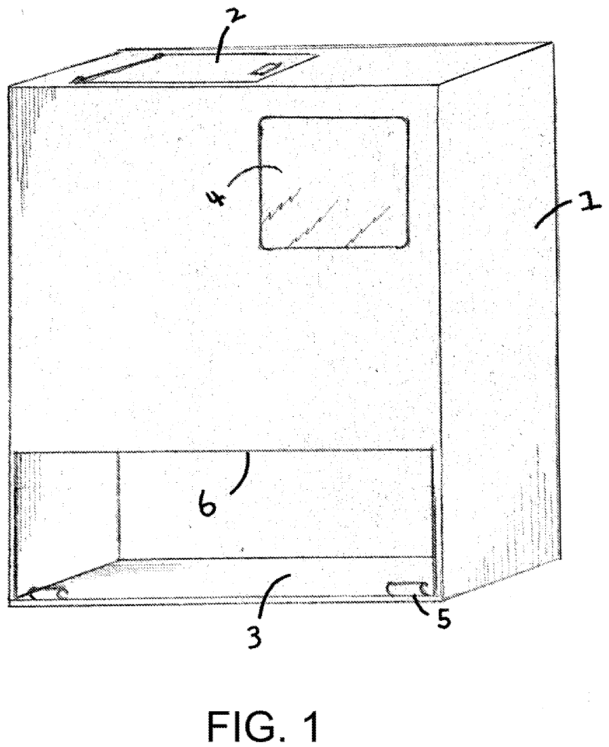

FIG. 1 shows the exterior cabinet generally rectangular in shape with a removable top hatch 2, an open cavity 3 at the bottom to hold the puzzle tray, LCD display 4, which can provide information concerning the operation of this invention, hooks 5 located at the bottom of cabinet 1 to hold the puzzle tray in place while reference numeral 6 identifies a gated hatch which allows food to be dispensed to the puzzle tray which is located therebelow. FIG. 1 describes and shows an automatic feeder utilizing a single puzzle tray extending from the lower portion of the feeder.

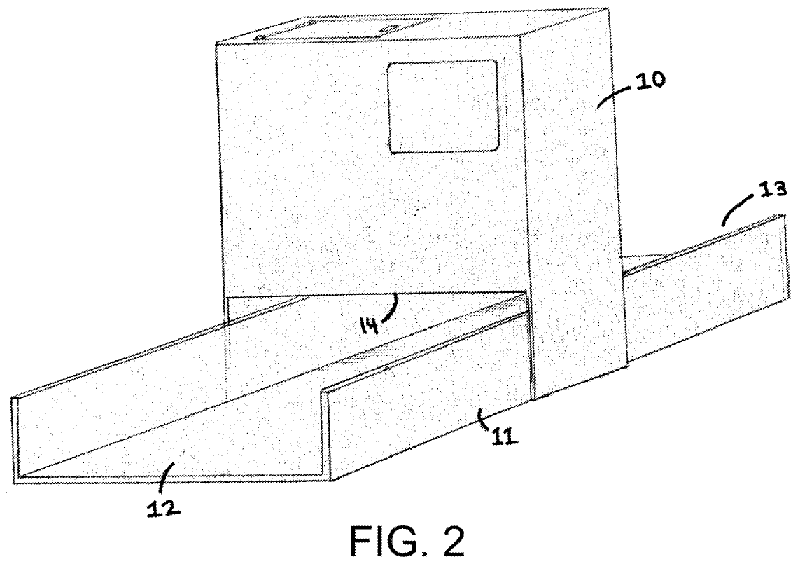

FIG. 2 is similar to FIG. 1 in which the cabinet 10 is located between the ends of puzzle tray holder 12 and is shown with the automatic feeder relatively centrally located. The puzzle is slid on a platform 11 which allows access to the food from both the front and rear 13 of the automatic feeder. Gated hatch 14 is similar to gated hatch 6 of FIG. 1 and allows food to be dispensed to the puzzle which is therebelow in platform or tray 21.

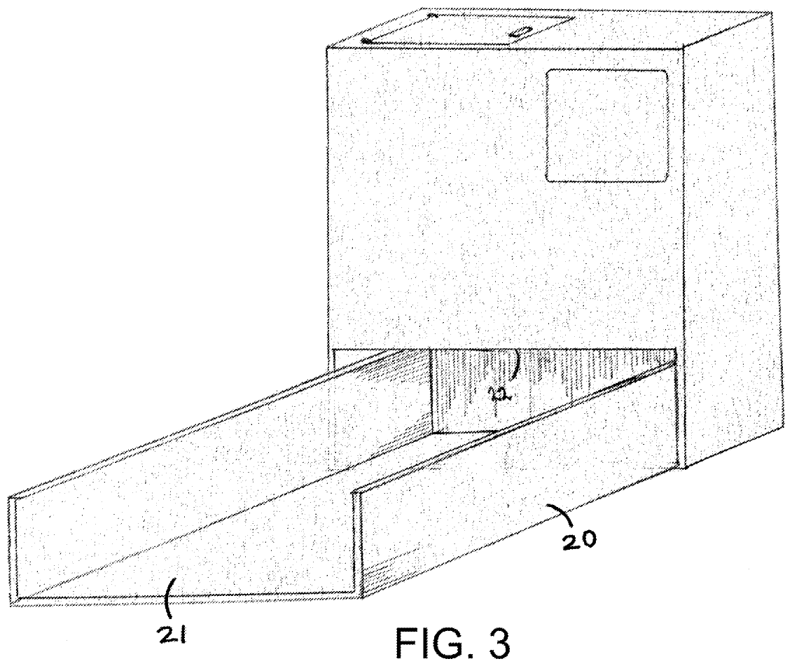

FIG. 3 utilizes the automatic feeder component of FIG. 1 with the platform 21 extending from one side. A gated hatch 22 is provided for the food to drop onto the puzzle tray.

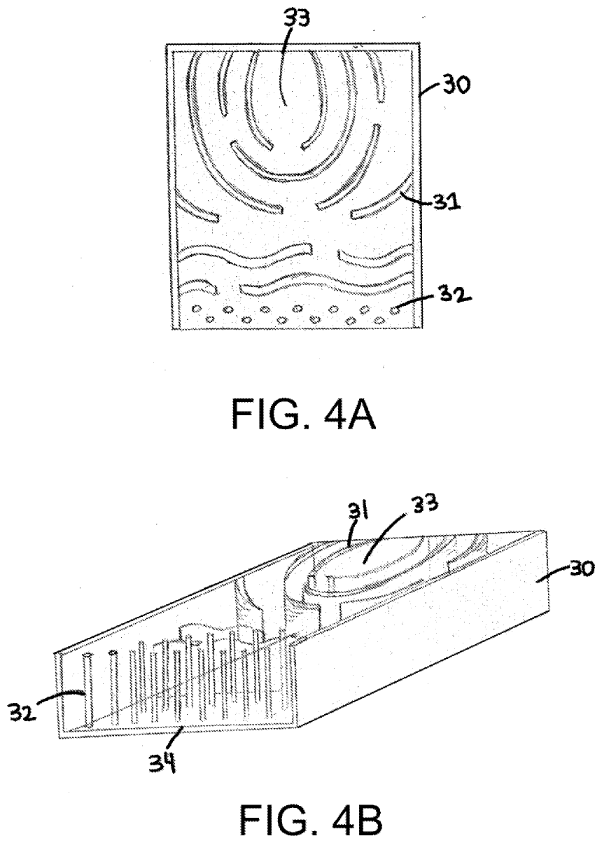

FIGS. 4A and 4B are top and front perspective views of a single direction dispenser into which food will be dispensed. The cat will retrieve food from the puzzles sitting in puzzle trays or holders 11 and 20 as described above. Reference numeral 30 identifies the outer surfaces of the puzzle which is shaped to fit within trays 11 and 20 and to be snugly held therein. Reference numerals 31 show an example of the puzzle portion, while food is generally dispensed in area 33 located in the rear portion of the puzzle tray. Vertical core plastic dividers 32 additionally present an obstacle for the cat to overcome to reach the food contained in area 33.

FIG. 5 is an alternative puzzle for use with the double-sided automatic feeder of FIG. 2. Food is dispensed into area 40 with plastic dividers 42 located on either side of the central area 40 as well as vertical cone plastic dividers 43 located at opposite ends of the tray. Access to the puzzle tray and food is provided at entrances 44 and 45. The tray in FIG. 5 is adapted to slide within the puzzle tray or holder 11 so that a bi-directional feeder is provided for more than one cat. Cats can be territorial, and a double feeder system allows for each cat to concurrently retrieve food or, in the alternative, retrieve food when desired with each cat generally utilizing the same side when feeding.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A pet feeder comprising an automatic food dispenser that dispenses pet food, and a puzzle tray with a plurality of spaced dividers surrounding a food reception area that receives the pet food from the automatic food dispenser.

2. The pet feeder of claim 1, wherein the automatic food dispenser has a gated hatch through which pet food is dispensed to the food reception area.

3. The pet feeder of claim 2, wherein, in operation, the gated hatch is located above the food reception area, and the pet food received in the food reception area is accessible to a pet from at least one side of the puzzle tray.

4. The pet feeder of claim 2, wherein, in operation, the gated hatch is located above the food reception area, and the pet food received in the food reception area is accessible to pets from opposite sides of the puzzle tray.

5. The pet feeder of claim 2, wherein, in operation, the gated hatch is located above the food reception area, and the pet food received in the food reception area is accessible to a pet only from one side of the puzzle tray.

6. The feeder of claim 2, wherein the puzzle tray is receivable in an opening in the automatic feeder that permits positioning at least the food reception area below the gated hatch.

7. The feeder of claim 6, wherein the opening permits the puzzle tray to pass through to permit access to the food reception from opposite sides of the puzzle tray by at least two pets once the food reception area is positioned below the gated hatch.

8. The feeder of claim 7, wherein the spaced dividers include a plurality of curved walls.

9. The feeder of claim 7, wherein the spaced dividers include a plurality of conical dividers.

10. The feeder of claim 7, wherein the spaced dividers include a plurality of curved walls and a plurality of conical dividers.

11. The feeder of claim 10, wherein the curved walls are located closer to the food reception area than the conical dividers.

12. The feeder of claim 1, wherein the automatic dispenser is programmable with a mobile device to set feeding times, quantity of dispensed pet food, or frequency of feeding.

13. The feeder of claim 12, wherein the automatic dispenser includes an interface for receiving programming instructions.

14. The feeder of claim 12, wherein the automatic feeder is WiFi-enabled to receive programming instructions.

15. The feeder of claim 12, wherein the automatic feeder is Bluetooth-enabled to receive programming instructions.

16. The feeder of claim 1, wherein the automatic feeder includes a camera that permits viewing a pet while the pet is interacting with the puzzle tray.

17. The feeder of claim 1, wherein the puzzle tray is made of plastic.

18. The feeder of claim 1, wherein the puzzle tray is made of stainless steel.
